(19) United States
(12) Patent Application Publication
(10) Pub. No.: US 2020/0238864 A1
(43) Pub. Date: Jul. 30, 2020

(54) SUPPORT FOR A MOTOR VEHICLE SEAT

(71) Applicant: FAURECIA AUTOSITZE GMBH, STADTHAGEN (DE)

(72) Inventors: SASCHA HEIDEN, STADTHAGEN (DE); CHRISTIAN NEYRINCK, STADTHAGEN (DE); VIKTORIYA CHERNYSH, PFORZHEIM (DE); JAVIER GIL, BARCELONA (ES); HÉLÉNE CHASSAING, HANNOVER (DE); TAMMO DE LIGNY, ETAMPES CEDEX (FR); DAGMAR BROCKSCHNIEDER, STADTHAGEN (DE); SILVIA KRÖMER, STADTHAGEN (DE)

(73) Assignee: FAURECIA AUTOSITZE GMBH, STADTHAGEN (DE)

(21) Appl. No.: 16/777,009

(22) Filed: Jan. 30, 2020

(30) Foreign Application Priority Data
Jan. 30, 2019 (DE) 10 2019 102 397.1

(51) Int. Cl. B60N 2/56; B60N 2/90; B60N 2/60

(52) U.S. Cl. CPC B60N 2/5621; B60N 2/6027; B60N 2/976

(57) ABSTRACT

A removable seat cushion with a massage and heating function which rests on a motor vehicle seat includes a support mat which can be arranged on the front of a backrest of a motor vehicle seat, a fastener configured to fasten the seat cushion to the motor vehicle seat, a plurality of actuators which are arranged on the support mat, and a heating device capable of heating the support mat, with the actuators being configured such that they are pneumatically operable.

### CROSS-REFERENCES TO RELATED APPLICATIONS

This application claims the priority of German Patent Application, Serial No. 10 2019 102 397.1, filed Jan. 30, 2019, pursuant to 35 U.S.G. 119(a)-(d), the disclosure of which is incorporated herein by reference in its entirety as if fully set forth herein.

### BACKGROUND OF THE INVENTION

The present invention relates to a removable seat cushion with a massage and heating function which rests on a motor vehicle seat.

The following discussion of related art is provided to assist the reader in understanding the advantages of the invention, and is not to be construed as an admission that this related art is prior art to this invention.

Driving long distances may cause strain for the occupants of motor vehicles, in particular for the driver. This can result in exhaustion due to a combination of a prolonged concentration phase, unchanged sitting posture, insufficient air circulation between the back of the occupant and the backrest of the motor vehicle seat, and a motor vehicle seat that is not or only inadequately adapted to the individual physical dimensions of the occupant. These strains are not only uncomfortable for the driver but may also endanger the safety of the driver and the safety of other road users if the signs of fatigue have a negative impact on the driver's performance.

One approach to reduce the strain, particularly for the driver, is to massage the back and buttocks while driving. Expensive motor vehicles often have motor vehicle seats with a massage function.

Seat cushions with a massage function are a cheaper alternative. Such seat cushions may also be flexibly used in other environments, for example in the workplace on office chairs or in the home for relaxation. The seat cushions are fastened to the seat using straps, bands (rubber) or other fastening means. In order to increase the effect of the massage and the well-being of the user, a heating function is built into many such seat cushions.

Document CN205871798U introduces a seat cushion that provides a massage function by means of air pockets. The air pockets comprise massage points that are designed as nubs that are filled and/or emptied by a pump and valves.

CN204432455U shows a seat cushion that achieves a massage function by using pneumatically driven massage balls. These balls are accommodated in a flexible rubber bladder.

The seat cushions presented here can be provided with a heating device equipped with heating elements, which usually use resistance heaters and heating cables in the seat cushion.

Conventional seat cushions with a massage function have many shortcomings. Due to the technology used (knobs or balls), the seat cushions are relatively thick. The additional components used to control and operate the air pockets or massage balls take up space in the seat cushion itself or in the interior of the motor vehicle and may increase the risk of injury to an occupant in the event of an accident.

The side airbags installed in the vehicle seat may be covered and not deploy correctly in the event of an accident.

For the reasons mentioned, the use of such seat cushions with a massage function while riding in or operating motor vehicles is generally outlawed. Occupants are furthermore able to feel the seat cushion even when it is not in use, which reduces the comfort for the occupant.

It would therefore be desirable and advantageous to provide an improved pneumatic seat cushion with a massage and heating function to obviate prior art shortcomings and to comply with legal requirements for use in particular while riding in or operating a motor vehicle.

### SUMMARY OF THE INVENTION

According to one aspect of the present invention, a removable seat cushion with a massage and heating function for placement on a motor vehicle seat includes a support mat configured for arrangement on a front of a backrest of a motor vehicle seat, a fastener configured to fasten the seat cushion to the motor vehicle seat, a plurality of actuators arranged on the support mat and configured for pneumatic operation, and a heating device configured to heat the support mat.

A removable seat cushion according to the present invention has a massage and heating function with a support mat which can be arranged on the front of the backrest of a motor vehicle seat. Furthermore, the removable seat cushion has a fastener with which the removable seat cushion can be fastened to the motor vehicle seat. A plurality of actuators and also a receiving device which is suitable for receiving at least one peripheral device are arranged on the support mat.

The receiving device is preferably fastened to the back of the backrest of the motor vehicle seat. The peripheral device contains the devices necessary for operating the seat cushion. This arrangement secures the peripheral device while the vehicle is operated and thus reduces the risk of injury to an occupant, in particular due to a rear-end collision.

The actuators can be designed as air pockets, which means that they are pneumatically filled and emptied by means of air. The seat cushion according to the invention offers the advantage that the massage function can also be used when the motor vehicle is in operation. The absence of mechanical components such as massage balls reduces the risk of injury to the occupant in the event of an accident and at the same time increases the comfort provided by a full massage function.

The heating device heats the support mat or the support element and thus has a beneficial effect on the user. The operation of the heating device can be coupled with or be independent from the operation of the massage device, and the heated surface or the heated surfaces may be part of the massage device or, with the elements being designed correspondingly, comprise the respective support mats or storage areas, which can also be used in particular in the non-use position. If necessary, several heating devices can be provided for this purpose as well.

In this way, the removable seat cushion with a massage and a heating function can, for example, be brought to a comfortable temperature before, during or after the massage. Thus, the seat cushion can also be used as a seat heater.

According to another advantageous feature of the present invention, the heating device can include a heating element, for example a heating wire. The heating element can be positioned at a lateral distance from the pneumatically operated actuators. The heating wire then functions as a resistance heater. It is particularly advantageous to integrate a flexible heating device, for example in the form of a heating fabric, which adapts to the contour of the motor vehicle seat and the contour of the occupant. To avoid damage to the actuators, the heating element is positioned at a distance from the actuators. If the heat is too strong, the actuators may leak or lose any plasticizers they may have, and the elasticity may be reduced.

According to another advantageous feature of the present invention, the heating element can have a distance from the actuators of at least 5 cm, preferably at least 3 cm and particularly preferably of 0.5 cm. To avoid damage to the actuators, the heating element can be positioned at a distance from the actuators. If the heat is too strong, the actuators may leak or lose any plasticizers they may have, and the elasticity may be reduced. It has been found that a distance s of at least 2 cm is sufficient to ensure the functionality of the actuators.

According to another advantageous feature of the present invention, the heating device can include a PTC auxiliary heater. A PTC (positive temperature coefficient) auxiliary heater generates heat by means of functional ceramics and cannot, due to its design, exceed a certain preset temperature. The advantage of using a PTC auxiliary heater is its quick response; the mat is heated within seconds. The PTC auxiliary heater can be used as an alternative or in addition to a resistance heater which is integrated into the support mat by using heating wires.

According to another advantageous feature of the present invention, the PTC auxiliary heater can heat the air with which the pneumatically operated actuators are filled. The PTC auxiliary heater is installed directly behind the air pump and heats the air with which the actuators are filled. When a PTC auxiliary heater is used exclusively, the support mat is therefore heated by the air in the actuators.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a front view of a removable seat cushion according to the present invention with a massage and heating function, which is fastened to a motor vehicle seat and ready for use;

FIG. 2 shows a side view of the removable seat cushion according to the present invention with a massage and heating function, which is fastened to a motor vehicle seat and ready for use;

FIG. 3 shows a rear view of the removable seat cushion according to the invention with a massage and heating function, which is fastened to a motor vehicle seat and ready for use;

FIG. 4 shows a top view of the removable seat cushion according to the invention with a massage and heating function and illustration of a heating device; and

FIG. 5 shows a representation of the seat cushion according to the invention with a massage function from an oblique rear left viewpoint.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

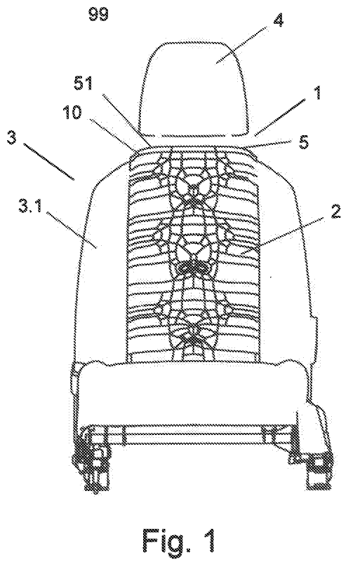

Turning now to the drawing, and in particular to FIG. 1, there is shown a front view of a removable seat cushion 1 according to the present invention with a massage and heating function, which is fastened to a motor vehicle seat 99 and ready for use. The removable seat cushion has a support mat 2 which is arranged on the front 3.1 of the backrest 3 of a motor vehicle seat 99, Furthermore, the removable seat cushion 1 has a fastener 10 with which the removable seat cushion 1 is fastened to the motor vehicle seat 99. The motor vehicle seat 99 itself has a headrest 4 which is located above the backrest 3.

The seat cushion 1 is fastened to the motor vehicle seat 99 with one or more fasteners 10. The lower area of the support mat 2 preferably has one strap 11 on each side of the support mat 2, which is guided around the lower area of the backrest 3 and encompasses the backrest 3. On the back of the backrest 3.2, both straps 11 are connected to one another, for example by an adjustable clip fastener or Velcro fastener. A cover 5 with an opening 51 is arranged on top of the support mat 2, This opening 51 is dimensioned such that the headrest 4 of the motor vehicle seat 99 can be passed through it. The cover 5 is connected to the support mat 2 by fastening means. These further fastening means connect the cover 5 to the sides of the backrest 3 of the motor vehicle seat 99. The fastener 10 and the further fastening means of the support mat 2 and the cover 5 are designed to be adjustable such that they can be adapted to the varying dimensions of different motor vehicle seats 99, for example by means of a Velcro fastener. As a result, the seat cushion 1 according to the invention is not only limited to being used in motor vehicles but also, for example, at the workplace on office chairs and at home. At the same time, a secure connection of the support mat 2 to the motor vehicle seat 99 is guaranteed; the support mat 2 cannot accidentally come off or slip.

A plurality of actuators 20, 21, 22, 23, 24, 25, 26, 27, 28, 29, which perform the actual massage, are arranged on the support mat 2. The actuators 20, 21, 22, 23, 24, 25, 26, 27, 28, 29 are arranged in a matrix in horizontally aligned rows and/or vertically aligned columns. In this exemplary embodiment, a total of 10 actuators 20, 21, 22, 23, 24, 25, 26, 27, 28, 29 are arranged in 5 rows and 2 columns. This arrangement of the actuators 20, 21, 22, 23, 24, 25, 26, 27, 28, 29 makes it possible to massage a large portion of an occupant's back and, at the same time, is so narrow that the side airbags in the motor vehicle seat 99 are not covered by the support mat 2. The distance d of a vertical column is less than d=10 cm, with less than d=5 cm being particularly preferred. The side airbags are therefore fully functional in the event of an accident.

A foam layer 2.1 is arranged on the actuators 20, 21, 22, 23, 24, 25, 26, 27, 28, 29 over such a large area that the actuators 20, 21, 22, 23, 24, 25, 26, 27, 28, 29 are ideally completely covered by the foam layer 2.1. When not in use (emptied actuators 20, 21, 22, 23, 24, 25, 26, 27, 28, 29), the support mat 2 cannot be or is hardly perceived by the occupant because the support mat 2 adapts almost perfectly to the contours of the motor vehicle seat 99.

Compared to seat cushions with a massage function known from prior art, the seat cushion 1 according to the invention also offers the advantage that the massage function can be used when the motor vehicle is in operation as well. The absence of mechanical components such as massage balls reduces the risk of injury to the occupant in the event of an accident and at the same time increases the comfort provided by a full massage function,

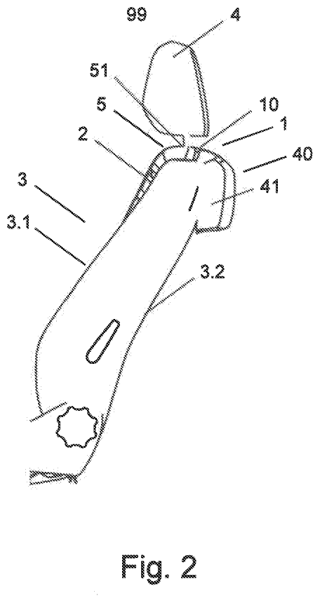

FIG. 2 shows a side view of the seat cushion 1 according to the invention, which is fastened to a motor vehicle seat 99 and ready for use. The support mat 2 is arranged on the front 3.1 of the backrest 3 of a motor vehicle seat 99, Furthermore, the removable seat cushion 1 has a fastener 10 with which the removable seat cushion 1 is fastened to the motor vehicle seat 99. The motor vehicle seat 99 itself has a headrest 4 which is located above the backrest 3.

The seat cushion 1 is fastened to the motor vehicle seat 99 with one or more fasteners 10. The lower area of the support mat 2 preferably has one strap 11 on each side of the support mat 2, which is guided around the lower area of the backrest 3 and encompasses the backrest 3. On the back of the backrest 3.2, both straps 11 are connected to one another, for example by a clip fastener or Velcro fastener. A cover 5 with an opening 51 is arranged on top of the support mat 2. This opening 51 is dimensioned such that the headrest 4 of the motor vehicle seat 99 can be passed through it. The cover 5 is connected to the support mat 2 by fastening means. These further fastening means connect the cover 5 to the sides of the backrest 3 of the motor vehicle seat 99. The fastener 10 and the further fastening means of the support mat 2 and the cover 5 are designed to be adjustable such that they can be adapted to the varying dimensions of different motor vehicle seats 99, for example by means of a Velcro fastener.

A plurality of actuators 20, 21, 22, 23, 24, 25, 26, 27, 28, 29, which perform the actual massage, are arranged on the support mat 2. The actuators 20, 21, 22, 23, 24, 25, 26, 27, 28, 29 are arranged in a matrix in horizontally aligned rows or vertically aligned columns. The actuators 20, 21, 22, 23, 24, 25, 26, 27, 28, 29 are designed as air pockets, which means that they are pneumatically filled and emptied by means of air. They are filled by an air pump 33 and a valve device 34 as well as hose connections, which are controlled by a controller 31.

The side of the support mat 2 facing the occupant consists of a flexible but robust fabric, which preferably does not cause sweating. On the side of the support mat 2 facing away from the occupant, there is an inlet that is reinforced but flexible such that almost all of the pressure that is generated by the pump 33 and the valve device 34 in the actuators 20, 21, 22, 23, 24, 25, 26, 27, 28, 29 is directed toward the back of the occupant. The controller 31, the pump 33 and the valve device 34 with the power supply 32 are accommodated in a peripheral device 30, which is fastened to the back of the backrest 3.2 of the motor vehicle seat 99.

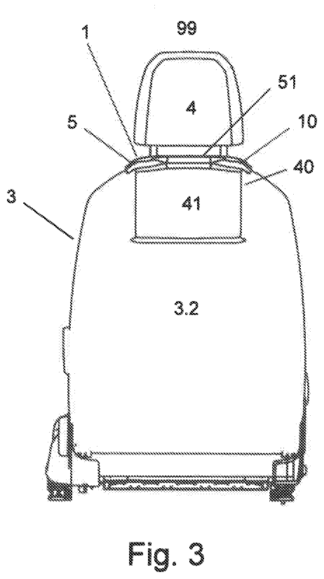

FIG. 3 shows a rear view of the seat cushion 1 according to the invention, which is fastened to a motor vehicle seat 99 and ready for use. The support mat 2 is arranged on the front 3.1 of the backrest 3 of a motor vehicle seat 99. Furthermore, the removable seat cushion 1 has a fastener 10 with which the removable seat cushion 1 is fastened to the motor vehicle seat 99. The motor vehicle seat 99 itself has a headrest 4 which is located above the backrest 3.

The seat cushion 1 is fastened to the motor vehicle seat 99 with one or more fasteners 10. A cover 5 with an opening 51 is arranged on top of the support mat 2. This opening 51 is dimensioned such that the headrest 4 of the motor vehicle seat 99 can be passed through it. The cover 5 is connected to the support mat 2 by fastening means. These further fastening means connect the cover 5 to the sides of the backrest 3 of the motor vehicle seat 99.

The actuators 20, 21, 22, 23, 24, 25, 26, 27, 28, 29 are filled by an air pump 33 and the valve device 34 as well as hose connections controlled by a controller 31. The controller 31, the pump 33 and the valve device 34 with the power supply 32 are accommodated in a peripheral device 30, which is fastened to the back of the backrest 3.2 of the motor vehicle seat. When the motor vehicle is in operation, the peripheral device 30 is secured by this arrangement, which thus reduces the risk of injury, in particular due to a rear-end collision.

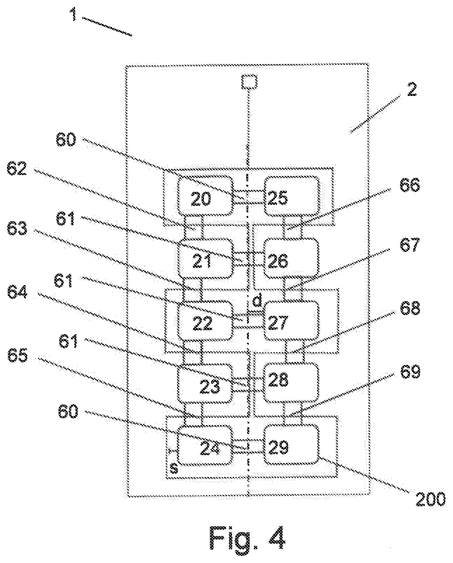

FIG. 4 shows a top view of the seat cushion 1 according to the invention with a heating device 200 with a heating element 210. The seat cushion 1 has a support mat 2 which is fastened to the front 3.1 of the backrest 3 of a motor vehicle seat 99. A plurality of actuators 20, 21, 22, 23, 24, 25, 26, 27, 28, 29, which which perform the actual massage, are arranged on the support mat 2. The actuators 20, 21, 22, 23, 24, 25, 26, 27, 28, 29 are arranged in a matrix in horizontally aligned rows and/or vertically aligned columns.

A cover 5 with an opening 51 is arranged on top of the support mat 2. This opening 51 is dimensioned such that the headrest 4 of the motor vehicle seat 99 can be passed through it. The cover 5 is connected to the support mat 2 by fastening means. These further fastening means connect the cover 5 to the sides of the backrest 3 of the motor vehicle seat 99. The receiving device 40 is fastened to the cover 5.

The receiving device 40 has fasteners 10 for fastening to the back of the backrest 3.2 of the motor vehicle seat 99 and furthermore a bag 41 for receiving the peripheral device 30. The bag 41 is ideally designed to be reclosable, for example by means of a zipper, so that the peripheral device 30 is easily accessible in the event of maintenance. Sound-absorbing elements, for example consisting of foam, can be arranged inside the bag 41 to reduce the noise generated by the peripheral device 30.

In this exemplary embodiment, the heating device 200 is integrated as a heating fabric, consisting of one or more heating wires, into the cover of the support mat 2, which covers the actuators 20, 21, 22, 23, 24, 25, 26, 27, 28, 29. The heating fabric is designed as a resistance heater, heats the support mat 2 and can have a beneficial effect on a user. The cable or cables of the heating device 200 are positioned at a lateral distance from the actuators 20, 21, 22, 23, 24, 25, 26, 27, 28, 29 in order to ensure that the function of the actuators 20, 21, 22, 23, 24, 25, 26, 27, 28, 29 is not affected. In the present example, the distance between the actuator and the heating wire was at least 7 cm. In other embodiments, the distance was at least 4 cm and at least 1 cm. If the heat is too strong, the foam layer 2.1 in the actuators 20, 21, 22, 23, 24, 25, 26, 27, 28, 29 may leak, lose any plasticizers it may have and lose its elasticity. A distance between the heating wire and the actuator 20, 21, 22, 23, 24, 25, 26, 27, 28, 29 of 0.5 cm is particularly preferred.

This way, the support mat 2 can be brought to a comfortable temperature before, during or after the massage. The seat cushion 1 according to the invention can therefore also be used as a seat heater. Alternatively or additionally, a PTC auxiliary heater can be installed in the receiving device 40. The PTC auxiliary heater is installed directly behind the pump 33 and heats the air with which the actuators 20, 21, 22, 23, 24, 25, 26, 27, 28, 29 are filled. If a PTC auxiliary heater is used exclusively, the support mat 2 is heated by the air in the actuators 20, 21, 22, 23, 24, 25, 26, 27, 28, 29. The advantage of using a PTC auxiliary heater is its quick response; the mat 2 is heated within seconds.

The peripheral device 30 comprises the controller 31, the pump 33, the valve device 34 and the power supply 32. The controller 31 usually comprises a microcomputer and control element, which has a corresponding program for controlling the pump 33 and the valve device 34. Using the controller 31, an occupant can start the massage process, choose from various massage programs and end the massage process. Each actuator 20, 21, 22, 23, 24, 25, 26, 27, 28, 29 is connected to the pump 33 via a direct hose connection 60, 61, 62, 63, 64, 65, 66, 67, 68, 69 and can therefore be individually filled or emptied independently from the other actuators 20, 21, 22, 23, 24, 25, 26, 27, 28, 29.

The power supply 32 is advantageously designed such that the seat cushion 1 can be operated completely independently by means of a current storage device (battery). It is also possible to operate the seat cushion 1 via the vehicle's electrical system. Power can be supplied, for example, from a socket (cigarette lighter), USB connection or the like. To use the seat cushion 1 outside a motor vehicle, a current transformer (for example a transformer with an AC/DC converter) can be inserted between the seat cushion 1 and the socket.

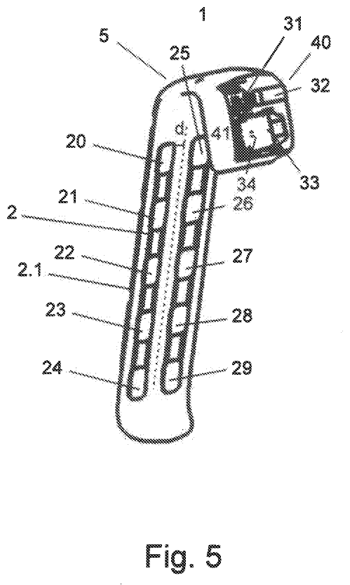

FIG. 5 shows an illustration of the seat cushion 1, which can be fastened to a seat and is ready for use, according to the invention from an oblique rear left aspect. The seat cushion 1 has a support mat 2 which is fastened to the front 3.1 of the backrest 3 of a motor vehicle seat 99. A plurality of actuators 20, 21, 22, 23, 24, 25, 26, 27, 28, 29, which perform the actual massage, are arranged on the support mat 2. The actuators 20, 21, 22, 23, 24, 25, 26, 27, 28, 29 are arranged in a matrix in horizontally aligned rows and/or vertically aligned columns.

A cover 5 with an opening 51 is arranged on top of the support mat 2. This opening 51 is dimensioned such that the headrest 4 of the motor vehicle seat 99 can be passed through it. The cover 5 is connected to the support mat 2 by fastening means. These further fastening means connect the cover 5 to the sides of the backrest 3 of the motor vehicle seat 99. The receiving device 40 is fastened to the cover 5.

The receiving device 40 has fasteners 10 for fastening to the back of the backrest 3.2 of the motor vehicle seat 99 and furthermore a bag 41 for receiving the peripheral device 30. The bag 41 is ideally designed to be reclosable, for example by means of a zipper, so that the peripheral device 30 is easily accessible in the event of maintenance. Sound-absorbing elements, for example consisting of foam, can be arranged inside the bag 41 to reduce the noise generated by the peripheral device 30.

The peripheral device 30 comprises the controller 31, the pump 33, the valve device 34 and the power supply 32. The controller 31 usually comprises a microcomputer and control element, which has a corresponding program for controlling the pump 33 and the valve device 34, Using the controller 31, an occupant can start the massage process, choose from various massage programs and end the massage process. Each actuator 20, 21, 22, 23, 24, 25, 26, 27, 28, 29 is connected to the pump 33 via a direct hose connection and can therefore be individually filled or emptied independently from the other actuators 20, 21, 22, 23, 24, 25, 26, 27, 28, 29.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A removable seat cushion with a massage and heating function for placement on a motor vehicle seat, said removable seat cushion comprising:
a support mat configured for arrangement on a front of a backrest of a motor vehicle seat;
a fastener configured to fasten the seat cushion to the motor vehicle seat;
a plurality of actuators arranged on the support mat and configured for pneumatic operation; and
a heating device configured to heat the support mat.

2. The removable seat cushion of claim 1, wherein the heating device includes a heating element which laterally spaced from the actuators.

3. The removable seat cushion of claim 2, wherein the heating element is spaced from the actuators at a distance of at least 7 cm.

4. The removable seat cushion of claim 2, wherein the heating element is spaced from the actuators at a distance of at least 4 cm.

5. The removable seat cushion of claim 2, wherein the heating element is spaced from the actuators at a distance of 1 cm.

6. The removable seat cushion of claim 1, wherein the heating device includes a PTC auxiliary heater.

7. The removable seat cushion of claim 6, wherein the PTC auxiliary heater heats air of the pneumatically operated actuators.
